(19) United States
(12) Patent Application Publication
(10) Pub. No.: US 2025/0150324 A1
(43) Pub. Date: May 8, 2025

(54) SEARCH APPARATUS, SEARCH METHOD, AND SEARCH PROGRAM

(71) Applicant: Nippon Telegraph and Telephone Corporation, Tokyo (JP)

(72) Inventors: Seiji SAKUMA, Musashino-shi, Tokyo (JP); Ryosuke SATO, Musashino-shi, Tokyo (JP); Mizuto NAKAMURA, Musashino-shi, Tokyo (JP); Kyoko YAMAGOE, Musashino-shi, Tokyo (JP)

(21) Appl. No.: 18/837,429

(22) PCT Filed: Feb. 21, 2022
(86) PCT No.: PCT/JP2022/006879

§ 371 Date: Aug. 9, 2024

(51) Int. Cl. H04L 41/0631; H04L 41/0677

(52) U.S. Cl. CPC H04L 41/0631; H04L 41/0677

(57) ABSTRACT

A search device 1 for searching for an investigation range of a failure occurring in a communication network includes a generation unit 16 configured to generate a graph in which a plurality of devices within a certain investigation range including a suspected failure location obtained by artificial intelligence (AI) are connected on the basis of a connection configuration of devices constituting a communication network, and
a search unit 17 configured to input the graph to a search model capable of searching for an investigation range on the basis of past failure results and to cause the search model to infer whether to extend the investigation range of the graph, and the generation unit 16 adds a neighboring device adjacent to a device in the graph to the graph in a case in which the investigation range of the graph needs to be extended.

### TECHNICAL FIELD

The present invention relates to a search device, a search method, and a search program.

### BACKGROUND ART

A self-evolved zero-touch operation in which an operation system autonomously adapts to an environmental change of a communication network has been studied. In addition, introduction of artificial intelligence (AI) into an operation system is in progress to realize this.

However, in order to ensure AI determination in consideration of various environmental changes of a communication network, it is necessary to further improve accuracy. In particular, on the premise that there is an error in a suspected failure location obtained by AI, there is a demand for a technology of searching for a failure investigation range on the basis of the premise.

That is, since there is a case in which an alarm information output device does not match a failed device, a case in which a network configuration at the time of failure occurrence is different from that at the time of construction, and the like in an actual communication network, it is not possible to simply select a neighboring device that has transmitted alarm information as an investigation range at the time of failure occurrence, and it is necessary to comprehensively investigate devices having a possibility of failure.

As a method of searching for a failure investigation range, there is a method of searching using a rule-based workflow. In addition, a method of searching by an operator himself/herself of a communication network is also conceivable. Furthermore, a method of searching using a graph search algorithm is also conceivable. Specifically, a breadth-first search method in which search is performed in order from a layer close to a start point, and a depth-first search method in which search is repeatedly performed by proceeding from a start point to an arbitrary dead end and then returning to a last branch are used (refer to Non Patent Literature 1).

### CITATION LIST

### Non Patent Literature

Non Patent Literature 1: Hideya Ochiai, “Discrete Mathematical Graph Search Algorithm”, [online], [retrieved on Feb. 1, 2022] <URL:
https://www.hongo.wide.ad.jp/˜jo21xq/dm/lecture/07.pdf>

### SUMMARY OF INVENTION

### Technical Problem

However, in the case of the search method based on a rule-based workflow, it is necessary to comprehensively consider complex conditional branches including changes in environmental conditions such as a failure event and a state at the time of occurrence of failure in a target communication network, and thus it is very difficult to create the workflow. In particular, it is unrealistic in a large-scale communication network in which the number of network devices is on the order of hundreds of thousands.

In addition, in the case of the search method of an operator, an investigation range is specified on the basis of the knowledge and experience of the operator, and thus it greatly depends on the skill of the individual, and the time taken from the occurrence of a failure to specification of the investigation range and conclusion are different.

In addition, in the case of the search method using the graph search algorithm, it is assumed that a search goal or a search goal condition is defined in advance, and thus a solution (quasi-suspicious location) cannot be derived in a communication network in which a condition is determined during searching. In the case of the depth-first search method, searching is performed up to the end point of a graph, and thus the calculation amount is always enormous in the large-scale communication network described above, and a lot of time is required until a search result is obtained.

The present invention has been made in view of the above circumstances, and an object of the present invention is to provide a technique capable of appropriately searching for a failure investigation range.

### Solution to Problem

A search device of an aspect of the present invention is a search device for searching for an investigation range of a failure occurring in a communication network, the search device including: a generation unit configured to generate a graph in which a plurality of devices within a certain investigation range including a suspected failure location obtained by artificial intelligence (AI) are connected on the basis of a connection configuration of devices constituting a communication network; and a search unit configured to input the graph to a search model capable of searching for an investigation range on the basis of past failure results and to cause the search model to infer whether to extend the investigation range of the graph, wherein the generation unit adds a neighboring device adjacent to a device in the graph to the graph in a case in which the investigation range of the graph needs to be extended.

A search method of an aspect of the present invention is a search method for searching for an investigation range of a failure occurring in a communication network, the search method, performed by a search device, including: a step of generating a graph in which a plurality of devices within a certain investigation range including a suspected failure location obtained by artificial intelligence (AI) are connected on the basis of a connection configuration of devices constituting a communication network; a step of inputting the graph to a search model capable of searching for an investigation range on the basis of past failure results and causing the search model to infer whether to extend the investigation range of the graph; and a step of adding a neighboring device adjacent to a device in the graph to the graph in a case in which the investigation range of the graph needs to be extended.

A search program according to an aspect of the present invention causes a computer to function as the search device.

### Advantageous Effects of Invention

According to the present invention, it is possible to provide a technique capable of appropriately searching for an investigation range of a failure.

### BRIEF DESCRIPTION OF DRAWINGS

FIG. 1 is a diagram illustrating a configuration of a search system.

FIG. 2 is a diagram illustrating a functional block configuration of a search device.

FIG. 3 is a diagram illustrating a processing flow of the search device.

FIG. 4 is a diagram illustrating an example of an initial graph.

FIG. 5 is a diagram illustrating an example of a graph after completion of update.

FIG. 6 is a diagram illustrating a hardware configuration of the search device.

### DESCRIPTION OF EMBODIMENTS

Hereinafter, embodiments of the present invention will be described with reference to the drawings. In the drawings, the same parts are denoted by the same reference numerals, and description thereof is omitted.

### Summary of Invention

The present invention discloses a technique capable of appropriately searching for a failure investigation range in order to ensure the safety of a recovery procedure against a failure of a communication network. Specifically, on the premise that there is an error in a suspected failure location obtained by AI, as described above, an investigation range including the suspected failure location is appropriately searched for. More specifically, the investigation range is suitably searched for on the basis of not only a suspicious device having the highest likelihood of failure at the time of occurrence of a failure of a communication network but also past failure results. Accordingly, it is possible to appropriately search for a failure investigation range and to improve the safety of a failure recovery operation.

### Configuration of Search System

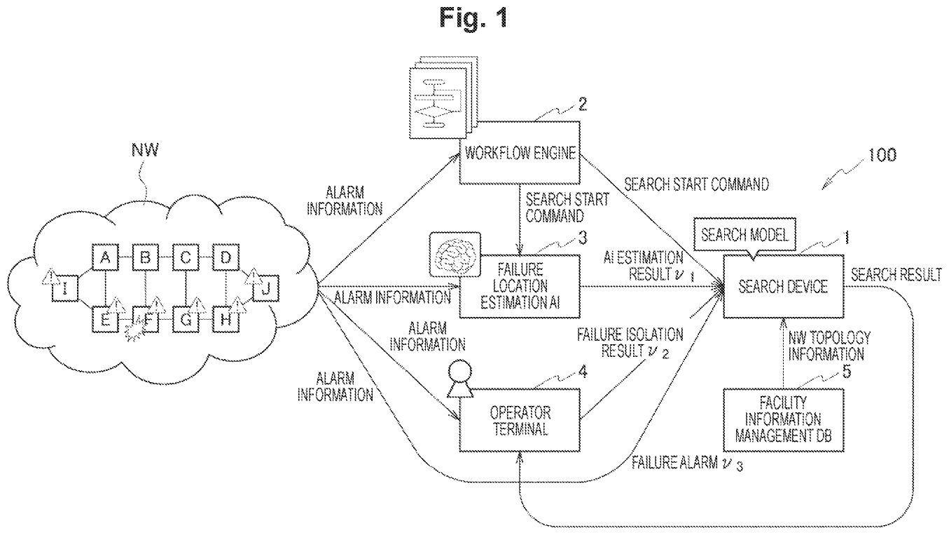

FIG. 1 is a diagram illustrating a configuration of a search system 100 according to the present embodiment. The search system 100 includes a search device 1, a workflow engine 2, a failure location estimation AI 3, an operator terminal 4, and a facility information management DB 5.

The workflow engine 2 is a device that performs automation of a failure recovery operation by utilizing an external system using a workflow. Specifically, the workflow engine 2 starts an automated operation flow on the basis of alarm information output from a communication network NW. The workflow engine 2 outputs a task start command (search start command) to the failure location estimation AI 3 and the search device 1 according to a branch on the flow.

The failure location estimation AI 3 is an AI machine or an AI program that estimates a suspected failure location. Specifically, the failure location estimation AI 3 receives alarm information output from the communication network NW and estimates a suspected failure location on the basis of the search start command output from the workflow engine 2.

The operator terminal 4 is a terminal operated by an operator to manage the communication network NW. Specifically, the operator terminal 4 outputs a suspected failure location estimated by the operator on the basis of the alarm information output from communication network NW.

The facility information management DB 5 is a database for managing various types of information of devices constituting the communication network NW. For example, the facility information management DB 5 stores a name of each device, an IP address of each device, a port number of each IF of each device, and NW topology information. The NW topology information is, for example, physical connection information (cable connection between device ports) and logical connection information (for example, connection between neighboring devices of a routing protocol and connection between end point devices of a tunneling protocol).

The search device 1 is a device that searches for an investigation range of a failure that has occurred in the communication network NW. As described above, there is a possibility that there is an error in a suspected failure location estimated by the failure location estimation AI 3. Therefore, the search device 1 searches for a failure investigation range using a search model of a graph neural network that has learned isolation investigation content for past failure events.

Specifically, the search device 1 generates a graph reflecting a topology configuration of the communication network NW to be searched and an AI estimation result (suspected failure location) obtained by the failure location estimation AI 3 in response to the search start command output from the workflow engine 2. Then, the search device 1 inputs the graph to the search model to determine (infer) the necessity of investigation of the surrounding of the suspected failure location, and adds the corresponding surrounding device to the graph in a case in which the investigation is necessary. Accordingly, it is possible to appropriately search for a failure investigation range and to improve the safety of a failure recovery operation.

In addition, the search device 1 further reflects, in the graph, not only the AI estimation result from the failure location estimation AI 3 but also failure isolation information from the operator output from the operator terminal 4 and failure information included in alarm information output from the communication network NW. Further, they may be directly input to the search model. Accordingly, it is possible to appropriately search for a failure investigation range and to improve the safety of the failure recovery operation.

In addition, the search device 1 further repeats determination (inference) of the necessity of investigation of surrounding devices according to the investigation result. Accordingly, it is possible to appropriately search for a failure investigation range and to improve the safety of the failure recovery operation.

### Functional Configuration of Search Device

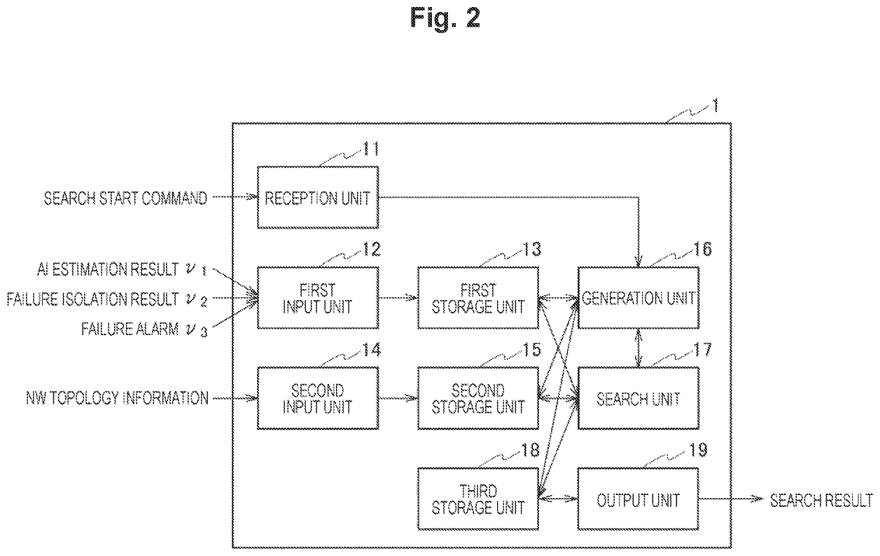

FIG. 2 is a diagram illustrating a functional block configuration of the search device 1 according to the present embodiment. The search device 1 includes a reception unit 11, a first input unit 12, a first storage unit 13, a second input unit 14, a second storage unit 15, a generation unit 16, a search unit 17, a third storage unit 18, and an output unit 19.

The reception unit 11 has a function of receiving a search start command output from the workflow engine 2 and notifying the generation unit 16 of the search start command.

The first input unit 12 has a function of inputting an AI estimation result from the failure location estimation AI 3, failure isolation information from the operator output from the operator terminal 4, and failure information included in alarm information output from the communication network NW, and storing various types of information such as the AI estimation result in the first storage unit 13.

The first storage unit 13 has a function of storing various types of information such as the AI estimation result input by the first input unit 12.

The second input unit 14 has a function of acquiring NW topology information of the communication network NW from the facility information management DB 5 and storing the NW topology information in the second storage unit 15.

The second storage unit 15 has a function of storing the NW topology information acquired by the second input unit 14.

The generation unit 16 has a function of generating a graph in which a plurality of devices within a certain investigation range including a suspected failure location estimated by the failure location estimation AI 3 are connected on the basis of a connection configuration of the devices constituting the communication network NW. Specifically, the generation unit 16 has a function of identifying a device suspected to have a failure, a device for which investigation information such as an alarm has been ascertained, and devices adjacent thereto on the basis of AI estimation results from the failure location estimation AI 3, the failure isolation information from the operator, and the failure information included in the alarm information, and generating a graph in which the identified devices are connected on the basis of the NW topology information of the communication network NW.

In addition, the generation unit 16 has a function of adding neighboring devices adjacent to the devices in the graph to the graph in a case in which the search unit 17 infers that the investigation range of the graph needs to be extended.

The search unit 17 has a function of learning an investigation range for isolating the graph generated by the generation unit 16 for past failures, inputting the investigation range to a search model of a graph neural network capable of searching for an investigation range on the basis of past failure results, and causing the search model to infer whether to extend the investigation range of the graph.

In addition, the search unit 17 has a function of inputting the failure isolation information from the operator to the search model during inference in the search model and causing the search model to perform inference using the failure isolation information.

In addition, the search unit 17 has a function of causing inference as to whether the investigation range of the graph to which the neighboring devices have been added needs to be further extended to be repeated one or more times according to a failure investigation result based on the alarm information output from the communication network NW.

The third storage unit 18 has a function of storing a graph.

The output unit 19 has a function of outputting a graph that is a failure investigation range search result.

### Processing of Search Device

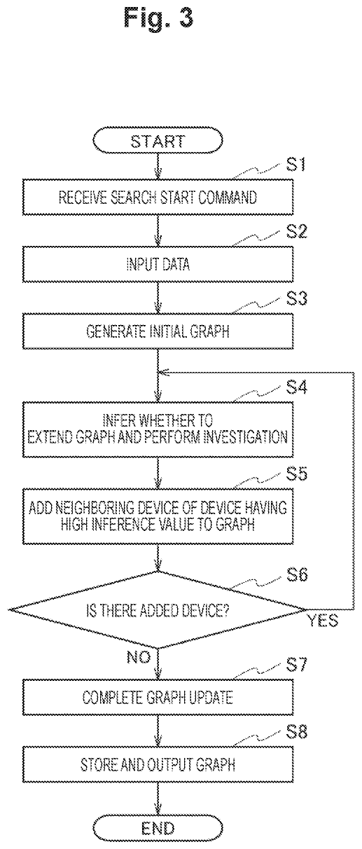

FIG. 3 is a diagram illustrating a processing flow of the search device 1 according to the present embodiment. A search method for searching for an investigation range of a failure occurring in the communication network NW will be described with reference to FIGS. 1 to 3. It is assumed that the workflow engine 2 starts an automated operation flow on the basis of alarm information output from the communication network NW and transmits a search start command to the workflow engine 2.

### Step S1

First, the reception unit 11 receives the search start command output from the workflow engine 2.

### Step S2

Next, the first input unit 12 inputs an AI estimation result v₁ with respect to a suspected failure location estimated by the failure location estimation AI 3, a failure isolation result v₂ estimated by the operator, and a failure alarm v₃ included in the alarm information for the communication network NW that has output the alarm information. In addition, the second input unit 14 acquires the NW topology information of the communication network NW from the facility information management DB 5.

The alarm information is an alarm, a system log, or the like, and is output from a plurality of devices for one failure (physical failure, link down, or the like). FIG. 1 illustrates a state in which an alarm is output from each of six devices E to J for a failure that has occurred in one device F.

### Step S3

Next, the generation unit 16 identifies a device suspected to have a failure, an ascertained device for which investigation information such as an alarm has been ascertained, and neighboring devices adjacent thereto on the basis of the AI estimation result v₁ from the failure location estimation AI 3, the failure isolation result v₂ from the operator, and the failure alarm v₃ included in the alarm information. Then, the generation unit 16 generates an initial graph in which the identified devices are connected on the basis of the NW topology information of the communication network NW.

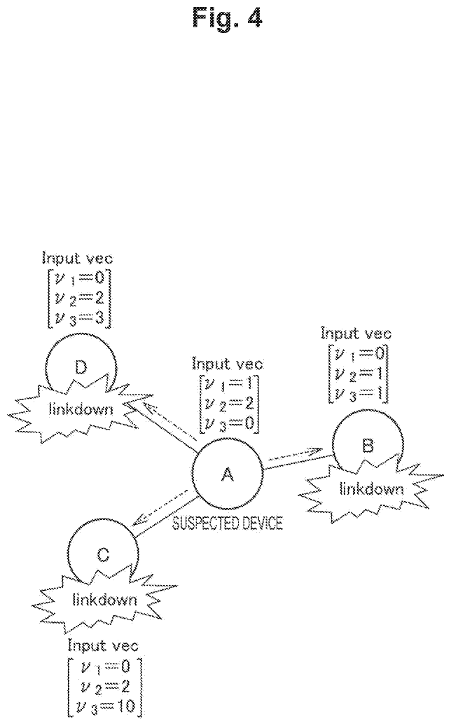

An example of the initial graph is shown in FIG. 4. For example, the generation unit 16 inputs a device A with (v₁=1) in the graph as a device suspected to have a failure. Next, the generation unit 16 further inputs devices B to D one hop ahead adjacent to the device A as neighboring devices in the graph, and inputs the values of v₂ and v₃ related to the devices B to D together in the graph.

### Step S4

Next, the search unit 17 learns an investigation range for dividing the initial graph for past failures and inputs the investigation range to a search model of a graph neural network capable of searching for an investigation range on the basis of past failure results, and causes the search model to infer whether to extend the investigation range of the initial graph. For example, the search model outputs an inference value h indicating the necessity of investigation extension for each device in the initial graph.

### Step S5

Next, the generation unit 16 updates the initial graph on the basis of the inference result obtained by the search model. Specifically, the generation unit 16 adds neighboring devices adjacent to the devices in the initial graph to the initial graph in a case in which it is inferred that the investigation range of the initial graph needs to be extended, and does not add the neighboring devices in a case in which it is inferred that the investigation range of the initial graph need not to be extended. For example, the generation unit 16 adds a neighboring device adjacent to a device having an inference value h equal to or greater than a threshold value huh to the initial graph, and does not add a neighboring device adjacent to a device having an inference value h less than the threshold value hₜₕ.

### Step S6

Thereafter, the generation unit 16 determines whether there is a device further adjacent to the devices added in step S5 on the basis of the NW topology information of the communication network NW. In a case in which there is a further neighboring device, processing returns to step S4 to infer whether the device is a device to be further added.

At this time, in a case in which an AI estimation result v₁′ after a change with the lapse of time, a failure isolation result v₂′ after the change, and a failure alarm v₃′ after the change are input to the search device 1, the search unit 17 may input them to the search model before or during inference to cause them to be inferred. In addition, the search unit 17 may repeatedly perform inference processing performed by the search model one or more times every time the AI estimation result v₁, the failure isolation result v₂, and the failure alarm v3 are changed according to a failure investigation result.

### Step S7

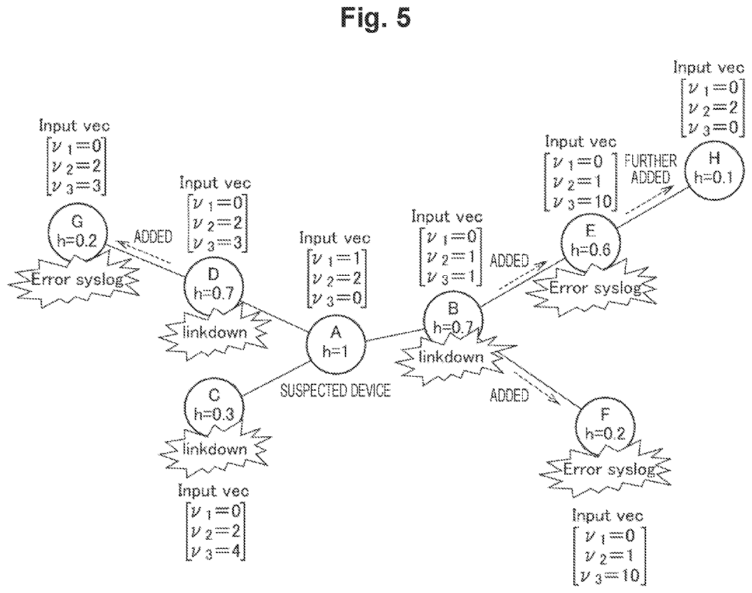

In a case in which there is no further neighboring device, the generation unit 16 completes graph update. FIG. 5 illustrates an example of a graph after completion of update. In this example, hₜₕ=0.5. A device E (h=0.6) adjacent to the device B (h=0.7) has been added. Furthermore, a device H (h=0.1) adjacent to the device E has been added. A device F (h=0.2) has been added for the device B (h=0.7). A device G (h=0.2) has been added for the device D (h=0.7). Since the device C, device F, device G, and device H have inference values less than h=0.5, neighboring devices thereof have not been added. The value of the failure alarm v₃ of the device C has been updated by the changed failure alarm v₃′.

### Step S8

Finally, the generation unit 16 stores the updated graph in the third storage unit 18. The output unit 19 outputs the graph to the operator terminal 4.

As described above, in the present embodiment, as an output of the search model, an investigation range reflecting the situation and change of each event is inferred by determining (inferring) “a degree of whether or not information of a certain device needs to be propagated to a neighboring device and determined with a larger graph (necessity of investigation extension)” instead of a simple device classification result, and extending a graph itself to be inferred. In addition, there is also a feature in that isolation information known by an operation is dynamically input to input data in the middle of the inference phase of device searching. Accordingly, it is possible to appropriately search for a failure investigation range and to improve the safety of a failure recovery operation.

### Effects

According to the present embodiment, the generation unit 16 that generates a graph in which a plurality of devices within a certain investigation range including a suspected failure location obtained by AI are connected on the basis of a connection configuration of devices constituting a communication network, and the search unit 17 that inputs the graph to a search model capable of searching for an investigation range on the basis of past failure results and causes the search model to infer whether to extend the investigation range of the graph are provided, and the generation unit 16 adds a neighboring device adjacent to a device in the graph to the graph in a case in which the investigation range of the graph needs to be extended, and thus a failure investigation range can be appropriately searched for, and the safety of a failure recovery operation can be improved.

In addition, according to the present embodiment, since the search unit 17 inputs the failure isolation information from the operator to the search model during inference in the search model and causes the search model to perform the inference using the failure isolation information, it is possible to more appropriately search for a failure investigation range and to further improve the safety of the failure recovery operation.

In addition, according to the present embodiment, the search unit 17 causes inference as to whether the investigation range of the graph to which the neighboring device has been added needs to be further extended to be repeated one or more times according to a failure investigation result based on alarm information from the communication network, and thus it is possible to more appropriately search for a failure investigation range and to further improve the safety of the failure recovery operation.

### Others

The present invention is not limited to the above embodiment. The present invention can be modified in various manners within the scope of the gist of the present invention.

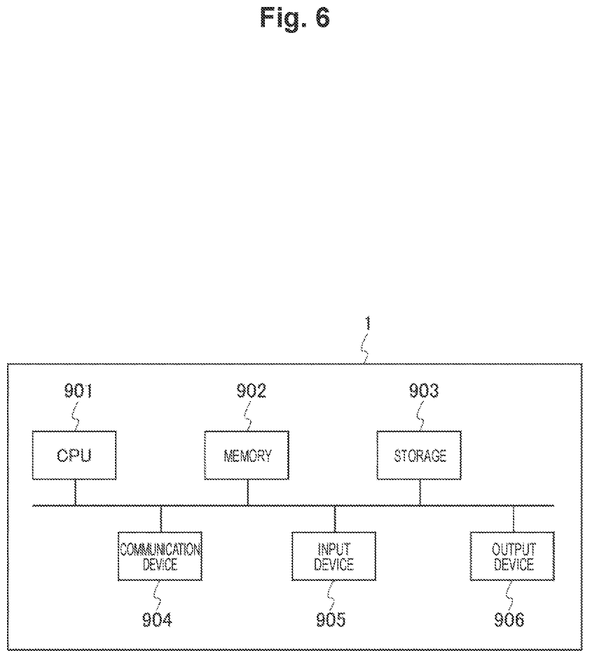

For example, as illustrated in FIG. 6, the search device 1 of the present embodiment described above can be realized using a general-purpose computer system including a CPU 901, a memory 902, a storage 903, a communication device 904, an input device 905, and an output device 906. The memory 902 and the storage 903 are storage devices. In the computer system, each function of the search device 1 is realized by the CPU 901 executing a predetermined program loaded on the memory 902.

The search device 1 may be mounted on one computer. The search device 1 may be mounted on a plurality of computers. The search device 1 may be a virtual machine mounted on a computer. The program for the search device 1 can be stored in a computer-readable recording medium such as an HDD, an SSD, a USB memory, a CD, or a DVD. The program for the search device 1 can also be distributed via a communication network.

### REFERENCE SIGNS LIST

1 Search device
11 Reception unit
12 First input unit
13 First storage unit
14 Second input unit
15 Second storage unit
16 Generation unit
17 Search unit
18 Third storage unit
19 Output unit
2 Workflow engine
3 Failure location estimation AI
4 Operator terminal
5 Facility information management DB
100 Search system
901 CPU
902 Memory
903 Storage
904 Communication device
905 Input device
906 Output device

1. A search device for searching for an investigation range of a failure occurring in a communication network, the search device comprising:
a generation unit, including one or more processors, configured to generate a graph in which a plurality of devices within a certain investigation range including a suspected failure location obtained by artificial intelligence (AI) are connected on the basis of a connection configuration of devices constituting a communication network; and
a search unit, including one or more processors, configured to input the graph to a search model capable of searching for an investigation range on the basis of past failure results and to cause the search model to infer whether to extend the investigation range of the graph, wherein the generation unit is configured to add a neighboring device adjacent to a device in the graph to the graph in a case in which the investigation range of the graph needs to be extended.

2. The search device according to claim 1, wherein the search unit is configured to input failure isolation information from an operator to the search model during inference in the search model, and cause the inference to be performed using the failure isolation information.

3. The search device according to claim 1, wherein the search unit is configured to cause inference as to whether the investigation range of the graph to which the neighboring device has been added needs to be further extended to be repeated one or more times according to a failure investigation result based on alarm information from the communication network.

4. The search device according to claim 1, wherein the search model is a graph neural network that has learned investigation ranges isolated for past failure.

5. A search method for searching for an investigation range of a failure occurring in a communication network, the search method, performed by a search device, comprising:
generating a graph in which a plurality of devices within a certain investigation range including a suspected failure location obtained by artificial intelligence (AI) are connected on the basis of a connection configuration of devices constituting a communication network;
inputting the graph to a search model capable of searching for an investigation range on the basis of past failure results and causing the search model to infer whether to extend the investigation range of the graph; and
adding a neighboring device adjacent to a device in the graph to the graph in a case in which the investigation range of the graph needs to be extended.

6. A non-transitory computer-readable storage medium storing a search program causing a computer to perform operations of a search method for searching for an investigation range of a failure occurring in a communication network, the operations comprising:
generating a graph in which a plurality of devices within a certain investigation range including a suspected failure location obtained by artificial intelligence (AI) are connected on the basis of a connection configuration of devices constituting a communication network;
inputting the graph to a search model capable of searching for an investigation range on the basis of past failure results and causing the search model to infer whether to extend the investigation range of the graph; and
adding a neighboring device adjacent to a device in the graph to the graph in a case in which the investigation range of the graph needs to be extended.

7. The search method according to claim 5, further comprising:
inputting failure isolation information from an operator to the search model during inference in the search model, and causing the inference to be performed using the failure isolation information.

8. The search method according to claim 5, further comprising:
causing inference as to whether the investigation range of the graph to which the neighboring device has been added needs to be further extended to be repeated one or more times according to a failure investigation result based on alarm information from the communication network.

9. The search method according to claim 5, wherein the search model is a graph neural network that has learned investigation ranges isolated for past failure.

10. The non-transitory computer-readable storage medium according to claim 6, wherein the operations further comprise:
inputting failure isolation information from an operator to the search model during inference in the search model, and causing the inference to be performed using the failure isolation information.

11. The non-transitory computer-readable storage medium according to claim 6, wherein the operations further comprise:
causing inference as to whether the investigation range of the graph to which the neighboring device has been added needs to be further extended to be repeated one or more times according to a failure investigation result based on alarm information from the communication network.

12. The non-transitory computer-readable storage medium according to claim 6, wherein the search model is a graph neural network that has learned investigation ranges isolated for past failure.
